(19) United States
(12) Patent Application Publication
(10) Pub. No.: US 2026/0172778 A1
(43) Pub. Date: Jun. 18, 2026

(54) PROBABILISTIC GEOFENCE TRACKING

(71) Applicant: QUALCOMM Incorporated, San Diego, CA (US)

(72) Inventors: Diyan TENG, Sunnyvale, CA (US); Mehul SOMAN, San Jose, CA (US); Rashmi KULKARNI, Redwood City, CA (US)

(21) Appl. No.: 18/986,648

(22) Filed: Dec. 18, 2024

(51) Int. Cl. H04W 4/021

(52) U.S. Cl. CPC H04W 4/021

(57) ABSTRACT

Techniques and systems are provided for geofencing. For instance, a process can include determining that a device is not within an existing geofence; determining that a memory space in a memory for storing geofence information is full; non-deterministically removing geofence information for an existing geofence from the memory space; and storing geofence information for a new geofence in the memory space.

### FIELD

The present application is related to geofencing.

### BACKGROUND

Satellite Positioning Systems and other positioning technologies have been used for locating persons, things, etc. by, for example, acquiring signals transmitted by transmitters located at fixed locations. In some cases, positioning technologies on a mobile device may periodically obtain position information indicating an estimated location of the mobile device. Using the position information, a location-based application may employ a geofence bounding a region of interest to detect entries into or exits from the region of interest. A geofence may comprise a virtual perimeter on a geographic area using a location-based service, so that events may be generated and/or actions taken in response to the monitored device entering or exiting the area.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for geofencing. In one illustrative example, an apparatus for geofencing is provided. The apparatus includes at least one memory and at least one processor coupled to the at least one memory. The at least one processor is configured to: determine that the apparatus is not within an existing geofence; determine that a memory space in the at least one memory for storing geofence information is full; non-deterministically remove geofence information for an existing geofence from the memory space; and store geofence information for a new geofence in the memory space.

In another example, a method for geofencing is provided. The method includes: determining that a device is not within an existing geofence; determining that a memory space in a memory for storing geofence information is full; non-deterministically removing geofence information for an existing geofence from the memory space; and storing geofence information for a new geofence in the memory space

As another example, non-transitory computer-readable medium having stored thereon instructions is provided. The instructions, when executed by at least one processor, cause the at least one processor to: determine that the apparatus is not within an existing geofence; determine that a memory space in the at least one memory for storing geofence information is full; non-deterministically remove geofence information for an existing geofence from the memory space; and store geofence information for a new geofence in the memory space.

In another example, an apparatus for geofencing is provided. The apparatus includes: means for determining that a device is not within an existing geofence; means for determining that a memory space in a memory for storing geofence information is full; means for non-deterministically removing geofence information for an existing geofence from the memory space; and means for storing geofence information for a new geofence in the memory space.

In some aspects, one or more of the apparatuses described herein comprises a mobile device (e.g., a mobile telephone or so-called “smart phone”, a tablet computer, or other type of mobile device), a tag reader or scanner, a wearable device, an extended reality device (e.g., a virtual reality (VR) device, an augmented reality (AR) device, or a mixed reality (MR) device), a personal computer, a laptop computer, a server device,, a vehicle (or a computing device of a vehicle), or other device. In some aspects, the apparatus(es) may include at least one camera for capturing one or more images or video frames. In some aspects, the apparatus(es) may include at least one display for displaying one or more images, videos, notifications, or other displayable data. In some aspects, the apparatus(es) includes at least one transmitter configured to transmit data to another device. In some aspects, the at least one processor includes a neural processing unit (NPU), a neural signal processor (NSP), a central processing unit (CPU), a graphics processing unit (GPU), any combination thereof, and/or other processing device or component. In some aspects, the apparatus(es) may include a system for determining a location or position of the apparatus(es), such as a Global Navigation Satellite System (GNSS) receivers or transceivers.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an example implementation of a system-on-a-chip (SOC), in accordance with some examples;

FIG. 2 illustrates an example environment for probabilistic geofence tracking, in accordance with aspects of the present disclosure;

FIG. 3 illustrates an example set of candidate geofences, in accordance with aspects of the present disclosure;

FIG. 4 is a flow diagram illustrating a process for probabilistic geofencing, in accordance with aspects of the present disclosure;

FIG. 5 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Geofencing may be performed by generating a virtual perimeter for a geographic area and tracking geofencing information, such as a location of the geofence, size of the geofence, an amount of time spent in the virtual perimeter, when a mobile device enters or leaves the virtual perimeter, a number of times the mobile device enters or leaves the virtual perimeter, and the like. Geofence information may then be used, for example, to perform location-based services, such as triggering a smart home action, automatic route tracking, mobile device setting adjustments, and the like.

In some cases, geofences and geofence information may be automatically created based on location information for a mobile device. In some examples, significant locations may be determined using automatically created geofences. These significant locations may be locations at which the mobile device is frequently located, such as a home, workplace, favorite restaurant, etc. of a user. The significant locations may then be used, for example, for personalization, establishing automatic actions, and the like.

Significant locations may be detected based on identifying a mobile device is at a new location and creating a new geofence based on the location. Geofence information for the new geofence may be stored in a memory space (e.g., buffer space, allocated memory, another data structure, or via other means). The memory space, data structure, or other means may be able to store a preconfigured or maximum amount of information or number of geofences. For example, a mobile device may have room for K number of geofences (e.g., geofence information corresponding to a geofence) to be stored in a buffer memory space. If the mobile device exits an existing geofence (e.g., candidate geofence), then a new geofence may be created and stored. If geofence information for K geofences have already been stored in the buffer memory space, geofence information for an existing geofence where the mobile device spent the least amount of time may be removed from the buffer and a new geofence created and stored in place of the removed geofence.

However, deterministically removing the geofence where the mobile device spent the least amount of time may not successfully identify significant locations for certain users, such as trade worker, delivery driver, postal worker, etc. For example, such users may be located at their workplace for a relatively short amount of time, after which the users may leave to go to a number of other locations (e.g., locations along a delivery route, client sites, etc.). Thus, improved techniques for geofence tracking may be useful.

Systems, apparatuses, processes (also referred to as methods), and computer-readable media (collectively referred to as “systems and techniques”) are described herein for providing systems and techniques for probabilistic geofence tracking. In some cases, a device may be configured to determine significant locations for a user of the device. The device may determine that the device is not within an existing geofence and attempt to create a new geofence. If memory space for storing geofence information of the device is full (e.g., already includes geofence information for K geofences), the device may non-deterministically remove geofence information for an existing geofence from the memory space and store geofence information for a new geofence in the memory space.

In some cases, the device may non-deterministically remove geofence information. In some cases, the device may non-deterministically remove geofence information based on a probability function, such as by using a Softmax activation function, a linear scale duration normalized probability mass function, a probability distribution function that takes an input of time of day and duration of stays within a geofence and outputting a probability distribution for dropping the geofence, etc. A Softmax activation function may convert a set of numbers into a probability distribution. Existing geofence information may be randomly removed based on a probability that is inversely proportional to an amount of time spent in an existing geofence. In some cases, an existing geofence may be prevented or protected from removal based on a comparison of the amount of time the device has spent in the existing geofence to a threshold amount of time. For example, the device may determine an amount of time the device has spent in an existing geofence, compare the amount of time to a threshold amount of time, and determine to prevent removal of the existing geofence based on the comparison (e.g., whether the amount of time exceeds the threshold). In some cases, geofences that have spent more than another threshold of time in the memory can be protected or prevented from the non-deterministic removal from the memory.

Various aspects of the application will be described with respect to the figures.

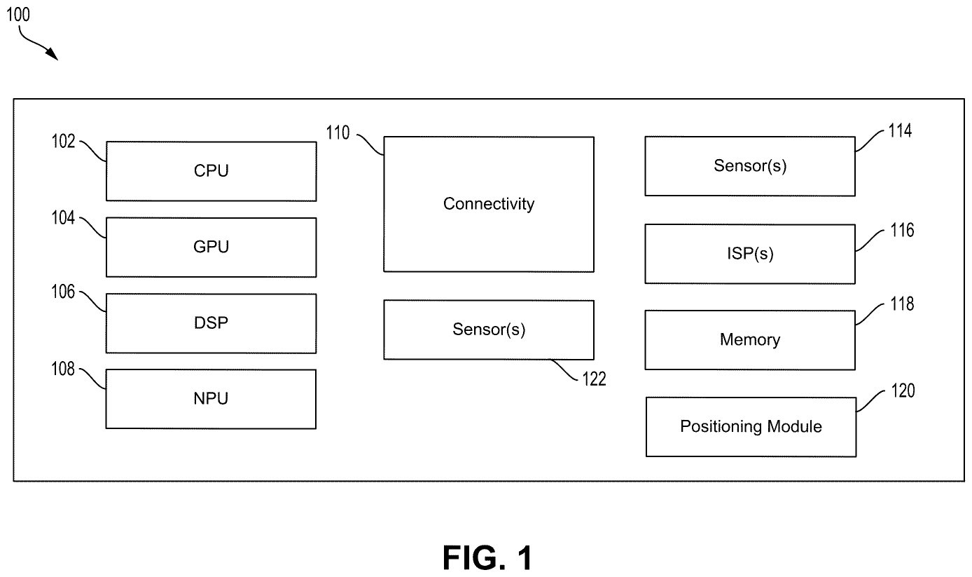

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, Ultrawideband (UWB) and the like. In one implementation, the NPU is implemented in the CPU 102, DSP 106, and/or GPU 104. The SoC 100 may also include a sensor processor 114, image signal processors (ISPs) 116, and/or positioning module 120 (which can also be referred to as a navigation module), which may include a global navigation satellite system (GNSS) and/or global positioning system (GPS).

SoC 100 and/or components thereof may be configured to evaluate environmental conditions. For example, the sensor processor 114 may receive and/or process information from one or more sensors 122. Examples of the one or more sensors 122 may include one or more Inertial Measurement Units (IMUs) (e.g., an accelerometer, a gyroscope, etc.), temperature sensors, light sensors, shock sensors, humidity sensors, acceleration sensors, speed sensors, tilt angle sensors, etc. sensors of a device. In some cases, the one or more sensors 122 may be located on SoC 100. In other cases, the sensor processor 114 may also be coupled to one or more sensors (not shown) that are external to the SoC 100 (e.g., located on a separate chip). In some cases, the sensor processor 114 may also receive, as input, output of one or more processing blocks of the connectivity block 110.

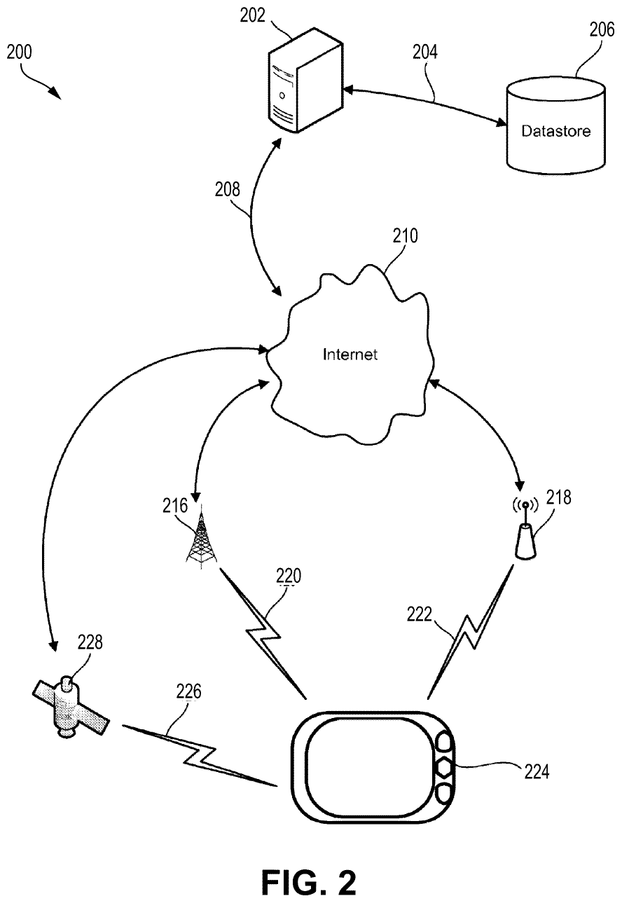

FIG. 2 illustrates an example environment for probabilistic geofence tracking, in accordance with aspects of the present disclosure. In some cases, a mobile device 224 may include one or more positioning modules (e.g., as a part of SoC 100 of FIG. 1) configured to determine a position or location of the mobile device 224, and a processor (e.g., as a part of SoC 100 of FIG. 1) configured to use the position information. The positioning module(s) and processor may be separate, or may be combined. In some examples, Global Navigation Satellite System (GNSS) receivers or transceivers are used to determine a location of the mobile device using GNSS signals 226 received from a number of GNSS satellites 228. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Other positioning techniques or components may be used. For example, the mobile device 224 may be configured to determine its location based on a triangulation of signals (e.g., 220) from a plurality of base stations (e.g., 216), a fingerprint of wireless signals (e.g., 222), etc.

The processor in the mobile device 224 may be configured with instructions for calculating its direction and speed of travel based on multiple position reports. The processor in the mobile device 224 may also be configured with executable instructions to analyze its location, speed and direction of travel, available directions of travel (e.g., trails, roads, shopping mall layouts, etc.), and/or current travel conditions to calculate a likely travel perimeter, as described in more detail below. The processor in the mobile device 224 may be configured with executable instructions to determine geofences for the mobile device. In some cases, the processor can cause a message including the determined geofences to be transmitted to a server 202 via one or more communication links such as a wireless wide area network (WWAN)) link 220 via a base station 216 or a local area network link 222 via an access point 218, which are in turn connected to a network 210 (e.g., the Internet). Examples of the base station 216 may include 3GPP gNB for 5G/NR, a 3GPP eNB for 4G/LTE, or other base station, and examples of an access point may include a Wi-Fi access point, Bluetooth access point, visible light communications access point, and the like. Alternatively, the processor in the mobile device 224 may be configured with executable instructions to transmit its current location, speed, and/or direction of travel as travel information in a request for an update of geofences.

The server 202 may be connected (e.g., via a local network 204) to a datastore 206 (or other type of memory). The datastore can store/maintain a database (e.g., global database) of geofences. The server 202 may be configured with executable instructions to receive messages from mobile devices 224. In some cases, the server 202 may store received geofences and/or travel information to the datastore 206.

In some cases, geofences for a mobile device may be automatically created based on movement of the mobile device. These automatically created geofences may be used to provide geographic context-based personalization for a user. For example, a mobile device may be able to detect that a user is on vacation, at home, work, etc., and the mobile device may adjust a setting, adjust content being provided, trigger an action, generate a report, etc. Generally, automatically created geofences apply algorithms to detect significant locations to geofence. These significant locations may be locations that the mobile device frequents (e.g., as a function of how long the mobile device is at a location). In some cases, these significant locations may then be evaluated to characterize the significant locations, for example, as home, work, gym, etc.

To detect significant locations, an application for identifying geofences representing significant locations executing on a mobile device may use a memory space (e.g., allocated memory space, available memory, hardware memory buffer, available buffer space, circular buffer, etc.) of a certain size for tracking candidate geofences (e.g., candidate significant locations). The memory space may accommodate geofence information for a certain maximum number K of candidate geofences or significant locations in total. In some cases, a deterministic technique for identifying geofences representing significant locations may be used. For example, based on a first location for the mobile device, a first candidate geofence of a certain size may be defined and geofence information for the first candidate geofence stored in the memory space. In some cases, the size of a candidate geofence may be configurable and/or adjustable. An amount of time (e.g., duration) the mobile device spends in a candidate geofence may be tracked and stored with the associated geofence information in the memory space.

When the mobile device leaves the first candidate geofence, a second candidate geofence may be created and an amount of time the mobile device spends in the second candidate geofence may be tracked. Geofence information for the second candidate geofence may also be stored in the memory space. If the mobile device reenters the first candidate geofence, the amount of time the mobile device has spent in the first candidate geofence may be incremented.

If the mobile device leaves an existing candidate geofence (e.g., first candidate geofence and second candidate geofence), another candidate geofence may be created. This process of creating new candidate geofences and storing associated geofence information in the memory space may be repeated as the mobile device leaves existing candidate geofences until a maximum number K of candidate geofences are stored in the memory space. After geofence information for K candidate geofences are stored, if the mobile device exits an existing candidate geofence, geofence information for an existing candidate geofence where the mobile device spent the least amount of time in may be located in the memory space and deleted and geofence information for a new candidate geofence may be stored in place of the deleted candidate geofence. Candidate geofences having relatively higher amounts of time (e.g., based on a threshold, a number of highest times, etc.) may be considered significant locations.

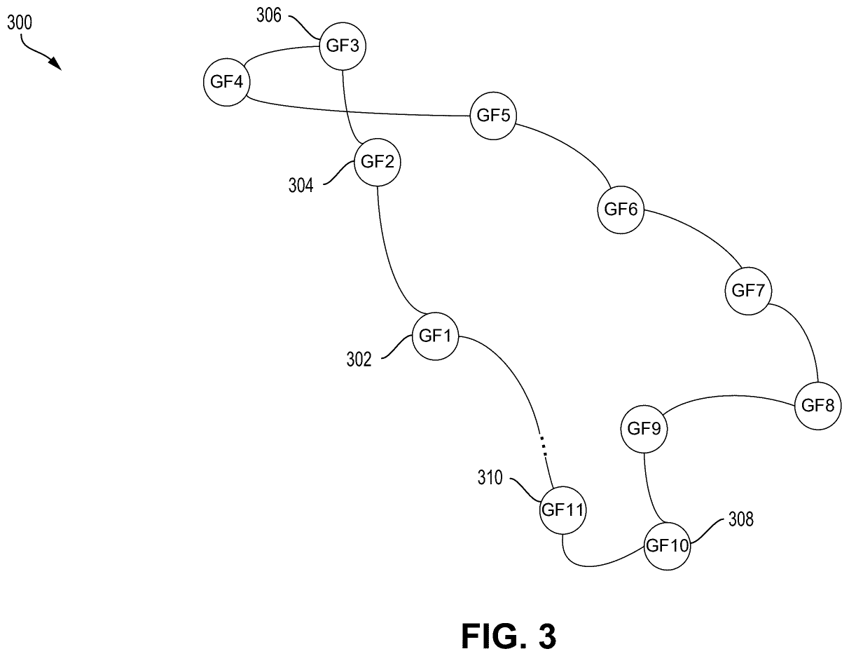

In some cases, the deterministic technique for detecting significant locations by removing a candidate geofence where a least amount of time was spent from the memory space to add a new candidate geofence may fail. FIG. 3 illustrates an example set of candidate geofences 300. In some cases, a user of a mobile device, such as trade worker, delivery driver, postal worker, police officer, etc. may arrive at a workplace where a first candidate geofence GF1 302 may be generated. In this example, a memory space may include space for geofence information for 10 candidate geofences. The user may stay at their workplace for a relatively short period of time (e.g., just long enough to pick up a vehicle, etc.) and the user may then leave for another location where a second candidate geofence GF2 304 may be generated. The user may then move on through a series of locations where candidate geofences GF3 306 GF10 308 are created.

At an eleventh location, a new candidate geofence GF11 310 may be created. The candidate geofence GF11 310 may be stored in the memory space over the geofence information for a previous candidate geofence. In some cases, depending on how long the user spent at the workplace, the geofence information for the first candidate geofence GF1 302 corresponding with the workplace may be replaced. The first candidate geofence GF1 302 may become more likely to be replaced as the number of candidate geofences increases depending on how long was spent in other candidate geofences (e.g., a long/complex delivery occurs). This spider web pattern of candidate geofences can be difficult to handle using a deterministic technique for creating geofences as described above. For example, as the user may not spend a sufficient duration per visit to their workplace, as compared to other locations (e.g., along a delivery route), the geofence information for the first candidate geofence GF1 302, corresponding with the workplace, may be replaced. While enlarging the memory space may address such issues, enlarging the memory space can be expensive, especially for low-cost devices, such as an internet of things (IoT) tracker, package tracking devices, and the like. In some cases, a probabilistic determination of which existing candidate geofence should be removed to allow for a new candidate geofence may be used to improve detection of significant locations.

To improve detection of significant locations, a non-deterministic technique for identifying geofences representing significant locations may be used. In the non-deterministic technique, candidate geofences may be added in a manner substantially similar to how geofence information for candidate geofences are added in the deterministic technique. In some cases, it may be useful to remove geofence information for previous geofences, for example after the memory space is full, in a non-deterministic manner. For example, rather than replacing an existing candidate geofence where the mobile device spent the least amount of time in, an existing candidate geofence may be non-deterministically removed.

Non-deterministically removing geofence information for an existing candidate geofence helps ensure, with a spider web pattern, that a “center” point (to which the mobile device periodically returns, regardless of where it is located physically), such as candidate geofence GF1 302 (e.g., the workplace) has a non-zero probability of being maintained. Where the center point (e.g., candidate geofence GF1 302) is maintained, when the mobile device returns to the center point, the amount time spent in the candidate geofence GF1 302 may increase. For example, the mobile device may leave candidate geofence GF11 310 and return to candidate geofence GF1 302.

If geofence information for candidate geofence GF1 302 has not been removed, a duration of time spent in the candidate geofence GF1 302 may continue to accumulate. As the mobile device may enter the center point (e.g., candidate geofence GF1 302) more than other candidate geofences (e.g., to pick up and drop off a delivery vehicle), even if the center point is non-deterministically dropped, the center point will get picked up and retained at some point and time spent in the center point will accumulate. In some cases, after a threshold amount of time has been spent in a candidate geofence, the candidate geofence may be prevented or protected from being non-deterministically removed. For example, based on a comparison between an amount of time that has been spent in a candidate geofence and a threshold amount of time, the candidate geofence may be protected from removal from the memory space. This threshold amount of time may be tunable. Thus, once the amount of time spent in the center point exceeds this threshold, the candidate geofence GF1 302 may be protected from being non-deterministically removed (e.g., the candidate geofence GF1 302 cannot be removed from the memory space), making the candidate geofence GF1 302 more likely to be identified as a significant location as the amount of time spent in candidate geofence GF1 302 accumulates.

In some cases, non-deterministic removal of geofence information for existing candidate geofences may be performed randomly or based on a probability function. In some examples, the geofence information for existing candidate geofences may be removed based on a probability inversely proportional to the amount of time spent (e.g., duration) in the candidate geofence. In some examples, a Softmax activation function may be applied to the duration values to generate a weight. The Softmax activation function may transform a set of duration values (d₁, d₂, . . . d_{K}) of the geofence information corresponding to the candidate geofences in the memory space to a probability distribution over the set of duration values.

In some cases, the probability function may be controlled using a forgetting factor control variable that operates on a probability that a candidate geofence may be dropped. For example, the set of duration values may be multiplied by a negative real number (α) to invert the duration values. This real number α may be used as a forgetting factor for the candidate geofences such that geofence information for existing candidate geofences may be removed from the memory space based on the function: softmax(−α*[d₁, d₂, . . . d_{K}]). In some cases, the forgetting factor may be tunable. Larger absolute values (e.g., |α|) for the forgetting factor increases the probability that shorter duration candidate geofences may be removed instead of longer duration geofences.

In some cases, non-deterministically removing geofence information for existing candidate geofences from the memory space when the memory space is full can be used to avoid using a larger sized memory space. This can make implementing determining significant location geofences easier for low power or memory devices, such as IoT devices, trackers, etc. Additionally, using a smaller sized memory space can help reduce processing power used to process the geofence information in the memory space. Further, as geofence tracking may be reduced once certain (e.g., a certain number of, certain type of, etc.) significant locations have been identified, non-deterministically removing geofence information for existing candidate geofences can help speed the identification of significant locations for users with a spider web pattern of candidate geofences.

In some cases, non-deterministically removing geofence information for existing candidate geofences may be used along with deterministically removing geofence information for existing candidate geofences with the shortest duration times. For example, deterministically removing geofence information for existing candidate geofences may be used for a period of time, and if a certain significant location (e.g., type of significant location, number of significant locations, etc.) has not been determined within the period of time, the device may switch to non-deterministically removing geofence information for existing candidate geofences. In another example, an operating mode of the device may switch between deterministically and non-deterministically removing geofence information for existing candidate geofences. As another example, switching between deterministically and non-deterministically removing geofence information for existing candidate geofences may be performed based on profession, use case, travel patterns, etc.

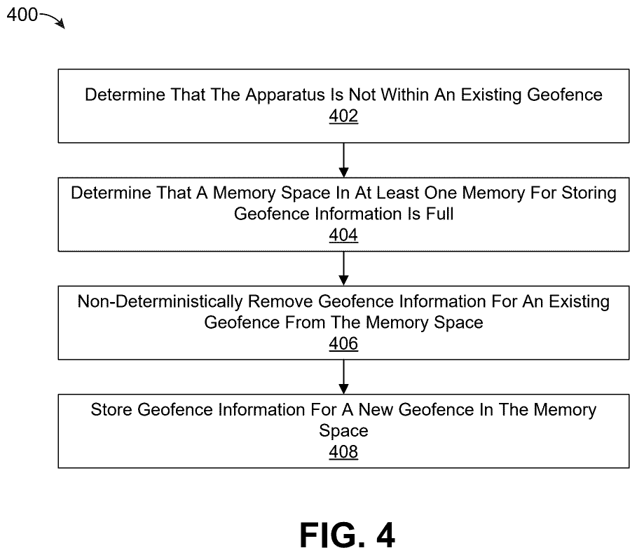

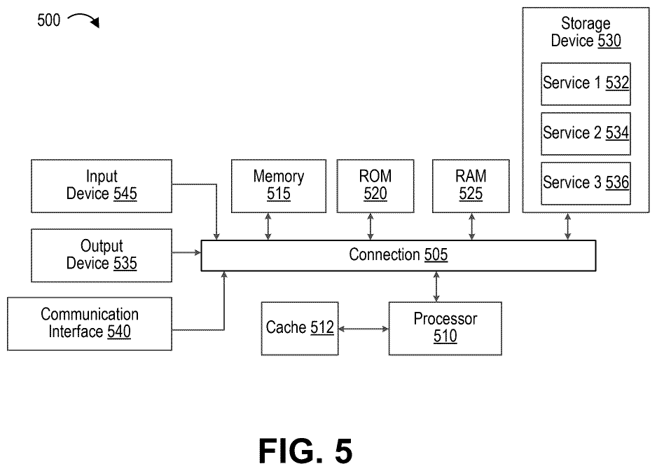

FIG. 4 is a flow diagram illustrating a process 400 for probabilistic geofencing, in accordance with aspects of the present disclosure. The process 400 may be performed by a computing device (e.g., apparatus, SoC 100 of FIG. 1, mobile device 224 of FIG. 2, computing system 500 of FIG. 5, etc.) or a component (e.g., a chipset, codec, etc., such as a CPU 102, GPU 104, DSP 106, NPU 108 of FIG. 1, processor 510 of FIG. 5, etc.) of the computing device. The computing device may be a mobile device (e.g., a mobile phone), a network-connected wearable such as a watch, an extended reality (XR) device such as a virtual reality (VR) device or augmented reality (AR) device, tag reader, scanner, a laptop computer, desktop computer, tablet, vehicle or component or system of a vehicle, or other type of computing device. The operations of the process 400 may be implemented as software components that are executed and run on one or more processors (e.g., processor 510 of FIG. 5, and/or other processor(s)). In some cases, the operations of the process 400 can be implemented by a system having the architecture of computing system 500 of FIG. 5.

At block 402, the computing device (or component thereof) may determine that the computing device (or component thereof) is not within an existing geofence. For example, the computing device may automatically create geofences based on movement of the mobile device such that when the computing device leaves a first geofence, a candidate geofence may be created.

At block 404, the computing device (or component thereof) may determine that a memory space in at least one memory for storing geofence information is full. The memory space may be any data structure, buffer, allocation of memory space, available memory, memory capacity, etc., capable of storing a preconfigured or maximum amount of information or number of geofences. For example, geofence information may be stored in a circular buffer of a certain size for tracking candidate geofences.

At block 406, the computing device (or component thereof) may non-deterministically remove geofence information for an existing geofence from the memory space. In some cases, the geofence information for an existing geofence is non-deterministically removed based on a probability function. In some examples, the probability function comprises at least one of a Softmax activation function or a linear scale duration normalized probability mass function. In some cases, the probability function is controlled using a forgetting factor variable for adjusting a probability that existing geofences with a shorter amount of time spent in the existing geofence will be removed. In some examples, the forgetting factor variable is tunable. In some cases, the geofence information for an existing geofence is non-deterministically removed based on a probability inversely proportional to an amount of time spent in the existing geofence. In some examples, the computing device (or component thereof) may determine a first existing geofence associated with a least amount of time spent in the first existing geofence as compared to amounts of time spent in other existing geofences; remove the first existing geofence based on the determination that the first existing geofence is associated with the least amount of time spent in the first existing geofence; and at another time determine to non-deterministically remove an existing geofence. For example, the computing device may support removing a candidate geofence when a least amount of time has been spent in that candidate geofence as compared to an amount of time spent in the other candidate geofences as well as non-deterministically removing candidate geofences, for example, based on an operating mode, information about a user, an amount of time or number of tries to determine a particular geofence, etc. In some cases, the determination to non-deterministically remove an existing geofence is based on at least one of: deterministically removing existing geofences after a period of time; or an operating mode of the apparatus. As an example of the former, if a certain significant location type (e.g., home, work, number of significant locations, etc.) has not been determined via deterministically (e.g., via a deterministic technique) removing existing geofences within the period of time, the device may switch to non-deterministically removing geofence information for existing candidate geofences.

At block 408, the computing device (or component thereof) may store geofence information for a new geofence in the memory space. In some cases, the computing device (or component thereof) may determine an amount of time spent in the new geofence. In some examples, the computing device (or component thereof) may prevent the new geofence from being removed from the memory space based on a comparison of the amount of time spent in the new geofence to a threshold amount of time. For example, after a certain threshold amount of time has been spent in a particular candidate geofence, the candidate geofence may be prevented or protected from being non-deterministically removed from the memory space.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some cases, the computing device may include a display for displaying images and/or a camera or other capture device for capturing images and/or video data. The computing device may further include a network interface, transceiver, and/or transmitter configured to communicate with another device. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 400 and/or other processes described herein may include a processor, microprocessor, micro-computer, or other component of a device that is configured to carry out the steps of the process 400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 400 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 is a diagram illustrating an example of a system for implementing certain aspects of the present technology. In particular, FIG. 5 illustrates an example of computing system 500, which can be for example any computing device making up internal computing system, a remote computing system, a camera, or any component thereof in which the components of the system are in communication with each other using connection 505. Connection 505 can be a physical connection using a bus, or a direct connection into processor 510, such as in a chipset architecture. Connection 505 can also be a virtual connection, networked connection, or logical connection.

In some examples, computing system 500 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 500 includes at least one processing unit (CPU or processor), such as processor 510, and connection 505 that couples various system components including system memory 515, such as read-only memory (ROM) 520 and random access memory (RAM) 525 to processor 510. Computing system 500 can include a cache 512 of high-speed memory connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, camera, accelerometers, gyroscopes, etc. Computing system 500 can also include output device 535, which can be one or more of a number of output mechanisms. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 530 can include software services, servers, services, etc., that when the code that defines such software is executed by the processor 510, it causes the system to perform a function. In some examples, a hardware service that performs a particular function can include the software component stored in a computer-readable medium in connection with the necessary hardware components, such as processor 510, connection 505, output device 535, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination oThe, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for performing one or more of the techniques described herein.

Illustrative aspects of the present disclosure include:

Aspect 1. An apparatus for geofencing, the apparatus comprising: at least one memory; and at least one processor coupled to the at least one memory, the at least one processor being configured to: determine that the apparatus is not within an existing geofence; determine that a memory space in the at least one memory for storing geofence information is full; non-deterministically remove geofence information for an existing geofence from the memory space; and store geofence information for a new geofence in the memory space.

Aspect 2. The apparatus of Aspect 1, wherein geofence information for an existing geofence is non-deterministically removed based on a probability function.

Aspect 3. The apparatus of Aspect 2, wherein the probability function comprises at least one of a Softmax activation function or a linear scale duration normalized probability mass function.

Aspect 4. The apparatus of any of Aspects 2-3, wherein the probability function is controlled using a forgetting factor variable for adjusting a probability that existing geofences with a shorter amount of time spent in the existing geofence will be removed.

Aspect 5. The apparatus of Aspect 4 wherein the forgetting factor variable is tunable.

Aspect 6. The apparatus of any of Aspects 2-5, wherein the geofence information for an existing geofence is non-deterministically removed based on a probability inversely proportional to an amount of time spent in the existing geofence.

Aspect 7. The apparatus of any of Aspects 1-6, wherein the at least one processor is configured to determine an amount of time spent in the new geofence.

Aspect 8. The apparatus of Aspect 7, wherein the at least one processor is configured to prevent removal of the new geofence from the memory space based on a comparison of the amount of time spent in the new geofence to a threshold amount of time.

Aspect 9. The apparatus of any of Aspects 1-8, wherein the at least one processor is further configured to: determine a first existing geofence associated with a least amount of time spent in the first existing geofence as compared to amounts of time spent in other existing geofences; remove the first existing geofence based on the determination that the first existing geofence is associated with the least amount of time spent in the first existing geofence; and determine to non-deterministically remove an existing geofence.

Aspect 10. The apparatus of Aspect 9, wherein the determination to non-deterministically remove an existing geofence is based on at least one of a period of time or an operating mode of the apparatus.

Aspect 11. A method for geofencing, comprising: determining that a device is not within an existing geofence; determining that a memory space in a memory for storing geofence information is full; non-deterministically removing geofence information for an existing geofence from the memory space; and storing geofence information for a new geofence in the memory space.

Aspect 12. The method of Aspect 11, wherein geofence information for an existing geofence is non-deterministically removed based on a probability function.

Aspect 13. The method of Aspect 12, wherein the probability function comprises at least one of a Softmax activation function or a linear scale duration normalized probability mass function.

Aspect 14. The method of any of Aspects 12-13, wherein the probability function is controlled using a forgetting factor variable for adjusting a probability that existing geofences with a shorter amount of time spent in the existing geofence will be removed.

Aspect 15. The method of Aspect 14 wherein the forgetting factor variable is tunable.

Aspect 16. The method of any of Aspects 12-15, wherein the geofence information for an existing geofence is non-deterministically removed based on a probability inversely proportional to an amount of time spent in the existing geofence.

Aspect 17. The method of any of Aspects 11-16, further comprising determining an amount of time spent in the new geofence.

Aspect 18. The method of Aspect 17, further comprising preventing removal of the new geofence from the memory space based on a comparison of the amount of time spent in the new geofence to a threshold amount of time.

Aspect 19. The method of any of Aspects 11-18, further comprising: determining a first existing geofence associated with a least amount of time spent in the first existing geofence as compared to amounts of time spent in other existing geofences; removing the first existing geofence based on the determination that the first existing geofence is associated with the least amount of time spent in the first existing geofence; and determining to non-deterministically remove an existing geofence.

Aspect 20. The method of Aspect 19, wherein the determination to non-deterministically remove an existing geofence is based on at least one of a period of time or an operating mode of the device.

Aspect 21. A non-transitory computer-readable medium having stored thereon instructions that, when executed by at least one processor, cause the at least one processor to performing one or more of operations according to any of Aspects 11 to 20

Aspect 22: An apparatus for geofencing, comprising means for performing one or more of operations according to any of Aspects 11 to 20.

What is claimed is:

1. An apparatus for geofencing, the apparatus comprising:
at least one memory; and
at least one processor coupled to the at least one memory, the at least one processor being configured to:
determine that the apparatus is not within an existing geofence;
determine that a memory space in the at least one memory for storing geofence information is full;
non-deterministically remove geofence information for an existing geofence from the memory space; and
store geofence information for a new geofence in the memory space.

2. The apparatus of claim 1, wherein geofence information for an existing geofence is non-deterministically removed based on one of a probability function or randomly.

3. The apparatus of claim 2, wherein the probability function comprises at least one of a Softmax activation function or a linear scale duration normalized probability mass function.

4. The apparatus of claim 2, wherein the probability function is controlled using a forgetting factor variable for adjusting a probability that existing geofences with a shorter amount of time spent in the existing geofence will be removed.

5. The apparatus of claim 4 wherein the forgetting factor variable is tunable.

6. The apparatus of claim 2, wherein the geofence information for an existing geofence is non-deterministically removed based on a probability inversely proportional to an amount of time spent in the existing geofence.

7. The apparatus of claim 1, wherein the at least one processor is configured to determine an amount of time spent in the new geofence.

8. The apparatus of claim 7, wherein the at least one processor is configured to prevent removal of the new geofence from the memory space based on a comparison of the amount of time spent in the new geofence to a threshold amount of time.

9. The apparatus of claim 1, wherein the at least one processor is further configured to:
determine a first existing geofence associated with a least amount of time spent in the first existing geofence as compared to amounts of time spent in other existing geofences;
remove the first existing geofence based on the determination that the first existing geofence is associated with the least amount of time spent in the first existing geofence; and
determine to non-deterministically remove an existing geofence.

10. The apparatus of claim 9, wherein the determination to non-deterministically remove an existing geofence is based on at least one of: an operating mode of the apparatus, or after a period of time deterministically removing existing geofences.

11. A method for geofencing, comprising:
determining that a device is not within an existing geofence;
determining that a memory space in a memory for storing geofence information is full;
non-deterministically removing geofence information for an existing geofence from the memory space; and
storing geofence information for a new geofence in the memory space.

12. The method of claim 11, wherein geofence information for an existing geofence is non-deterministically removed based on one of a probability function or randomly.

13. The method of claim 12, wherein the probability function comprises at least one of a Softmax activation function or a linear scale duration normalized probability mass function.

14. The method of claim 12, wherein the probability function is controlled using a forgetting factor variable for adjusting a probability that existing geofences with a shorter amount of time spent in the existing geofence will be removed.

15. The method of claim 14 wherein the forgetting factor variable is tunable.

16. The method of claim 12, wherein the geofence information for an existing geofence is non-deterministically removed based on a probability inversely proportional to an amount of time spent in the existing geofence.

17. The method of claim 11, further comprising determining an amount of time spent in the new geofence.

18. The method of claim 17, further comprising preventing removal of the new geofence from the memory space based on a comparison of the amount of time spent in the new geofence to a threshold amount of time.

19. The method of claim 11, further comprising:
determining a first existing geofence associated with a least amount of time spent in the first existing geofence as compared to amounts of time spent in other existing geofences;
removing the first existing geofence based on the determination that the first existing geofence is associated with the least amount of time spent in the first existing geofence; and
determining to non-deterministically remove an existing geofence.

20. The method of claim 19, wherein the determination to non-deterministically remove an existing geofence is based on at least one of: an operating mode of the device, or after a period of time deterministically removing existing geofences.
